(19) United States
(12) Patent Application Publication
(10) Pub. No.: US 2023/0273606 A1
(43) Pub. Date: Aug. 31, 2023

(54) MANUFACTURING STEP MANAGEMENT SYSTEM, MANUFACTURING STEP MANAGEMENT DEVICE, MANUFACTURING STEP MANAGEMENT METHOD, AND PROGRAM

(71) Applicant: KANEKA CORPORATION, Osaka (JP)

(72) Inventors: Shota TAKAMUKU, Akashi-shi (JP); Masaki FUKUDA, Himeji-shi (JP)

(73) Assignee: KANEKA CORPORATION, Osaka (JP)

(21) Appl. No.: 18/006,851

(22) PCT Filed: Jun. 1, 2021
(86) PCT No.: PCT/JP2021/020842

§ 371 Date: Jan. 25, 2023

(30) Foreign Application Priority Data
Jul. 28, 2020 (JP) 2020-127203
Mar. 4, 2021 (JP) 2021-034632

(51) Int. Cl. G05B 19/418; D01D 10/04

(52) U.S. Cl. CPC G05B 19/41875; D01D 10/0436; G05B 2219/32368

(57) ABSTRACT

A manufacturing step management system includes: a support member configured to come into contact with a workpiece that moves in a state in which tension is applied and to support the workpiece; an acquirer configured to acquire information about variance of a mechanical change on the basis of the mechanical change in the support member; and an estimator configured to estimate the tension applied to the workpiece.

### TECHNICAL FIELD

The present invention relates to a method of measuring tension applied to a workpiece for use in a process of molding a sheet, a film, a fiber, or the like and the like and a management device therefor. In particular, the present invention relates to a manufacturing step management system, a manufacturing step management device, a manufacturing step management method, and a program for measuring the tension of yarn in a spinning process for synthetic resin fibers at any position in a contactless state.

Priority is claimed on Japanese Patent Application No. 2020-127203, filed Jul. 28, 2020, and Japanese Patent Application No. 2021-034632, filed Mar. 4, 2021, the content of which is incorporated herein by reference.

### BACKGROUND ART

Conventionally, sheets, films, and fibers are produced from resin. Production processes include a molding process involving large deformation of resin using a roll. As the production process, for example, a process of molding resin in a thin-film shape, a process of spinning the resin discharged from a spinning nozzle, and the like are known. Although it is known that the history of deformation applied in such a process is stored in the resin as residual distortion and strongly affects the quality of a product and processing stability, the introduction of sensing technology has been postponed due to physical restrictions and economic restrictions in many cases. Within the process, shrinkage stress is generated due to the relaxation of residual distortion and can be detected as the tension of the workpiece. In particular, in the spinning process for synthetic resin fibers, excessively strong tension adversely affects the physical characteristics of the product yarn and leads to yarn breakage and winding around the process roll in the process. In contrast, excessively weak tension also adversely affects the physical characteristics of the product yarn, leads to slack in the process yarn, makes the running of the yarn unstable, causes the yarn to be easily damaged, and causes the yarn breakage. In this way, in the molding process using rolls, the tension of the workpiece is an important process control index and various types of technologies for managing the quality of the processed resin and the process based on the resin tension have been proposed.

For example, the following Patent Literature 1 discloses technology related to a device for directly measuring tension applied to a web using a sensor device in a manufacturing process for the web that is a strip- or thread-shaped member formed of resin such as plastic, cloth, paper, metal, or the like and controlling tension to be applied to the web on the basis of a measured value.

Also, the following Patent Literature 2 discloses technology related to a system for monitoring a change in tension vibrations in a frequency domain by performing a fast Fourier transform on the tension of yarn that has been acquired and controlling and managing an abnormality of the yarn and the quality of the yarn that has been processed.

Further, the following Patent Literature 3 discloses technology related to a measurement method and device for irradiating a small amount of yarn with infrared light and detecting the tension of the yarn from transmitted light such that the tension of the yarn is detected in a contactless state.

The following Patent Literature 4 describes technology related to a method of applying vibrations to a belt, acquiring the vibrations at that time with an acceleration sensor, obtaining a natural frequency by performing a Fourier transform on the vibrations, and calculating the tension of the belt from a vibration frequency that has been obtained.

### CITATION LIST

### Patent Literatures

[Patent Literature 1]
   Japanese Unexamined Patent Application, First Publication No. 2019-197036
[Patent Literature 2]
   Japanese Unexamined Patent Application, First Publication No. 2000-220043
[Patent Literature 3]
   Japanese Unexamined Patent Application, First Publication No. 2002-88606
[Patent Literature 4]
   Japanese Unexamined Patent Application, First Publication No. 2018-9989

### SUMMARY OF INVENTION

### Technical Problem

However, the technologies shown in the literature of the prior art may require the introduction of a large-scale facility to directly measure the tension applied to the workpiece as in Patent Literature 1 and may be applicable to a small amount of fiber as in Patent Literature 2 or Patent Literature 3. Therefore, there is a problem that a facility to which these technologies can be applied is required to be a large-scale facility or a process to which these technologies can be applied is limited to a process of handling a small amount of yarn bundle or the like.

Further, when the tension is calculated by obtaining a frequency from vibrations of a tension monitoring target instead of directly measuring the tension as in Patent Literature 4, prior work for applying vibrations to the tension monitoring target, calculating a natural frequency from a change in acceleration that has been detected, and identifying whether or not the natural frequency is due to the vibrations of a belt is required.

In view of the above-described problems, an objective of the present invention is to provide a manufacturing step management system, a manufacturing step management device, a manufacturing step management method, and a program capable of easily performing manufacturing step management.

### Solution to Problem

To solve the above-described problem, a manufacturing step management system according to one aspect of the present invention includes: a support member configured to come into contact with a workpiece that moves in a state in which tension is applied and to support the workpiece; an acquirer configured to acquire information about variance of a mechanical change on the basis of the mechanical change in the support member; and an estimator configured to estimate the tension applied to the workpiece.

A manufacturing step management device according to one aspect of the present invention includes: an acquirer configured to acquire information about variance of a mechanical change on the basis of the mechanical change in a support member configured to come into contact with a workpiece that moves in a state in which tension is applied and to support the workpiece; and an estimator configured to estimate the tension applied to the workpiece.

A manufacturing step management method according to one aspect of the present invention includes: acquiring, by an acquirer, information about variance of a mechanical change on the basis of the mechanical change in a support member configured to come into contact with a workpiece that moves in a state in which tension is applied and to support the workpiece; and estimating, by an estimator, the tension applied to the workpiece.

A program, according to one aspect of the present invention, causes a computer to function as: an acquirer configured to acquire information about variance of a mechanical change on the basis of the mechanical change in a support member configured to come into contact with a workpiece that moves in a state in which tension is applied and to support the workpiece; and an estimator configured to estimate the tension applied to the workpiece.

### Advantageous Effects of Invention

According to the present invention, it is possible to easily perform manufacturing step management.

### BRIEF DESCRIPTION OF DRAWINGS

FIG. 1 is a diagram showing an example of manufacturing steps for a workpiece according to an embodiment of the present invention.

FIG. 2 is a diagram showing an example of a configuration of a roll device according to the embodiment of the present invention.

FIG. 3 is a block diagram showing an example of a functional configuration of a manufacturing step management system according to the embodiment of the present invention.

FIG. 4 is a flowchart showing a flow of a process of the manufacturing step management system according to the embodiment of the present invention.

FIG. 5A is a graph showing a time-series change in tension applied to a resin processed product measured by a tension sensor according to an embodiment example of the embodiment of the present invention.

FIG. 5B is a graph showing a time-series change in variance of acceleration of a roll device 10 measured by an acceleration sensor according to an embodiment example of the embodiment of the present invention.

FIG. 6 is a flowchart showing a flow of a process of the manufacturing step management system according to a third modified example of the present invention.

FIG. 7A is a diagram showing a relationship between tension and acceleration according to the presence or absence of a statistical process according to an embodiment example of the third modified example of the present invention.

FIG. 7B is a diagram showing a relationship between tension and acceleration according to the presence or absence of a statistical process according to an embodiment example of the third modified example of the present invention.

FIG. 7C is a diagram showing a relationship between tension and acceleration according to the presence or absence of a statistical process according to an embodiment example of the third modified example of the present invention.

FIG. 7D is a diagram showing a relationship between tension and acceleration according to the presence or absence of a statistical process according to an embodiment example of the third modified example of the present invention.

FIG. 8A is a graph showing a time-series change in tension applied to a resin processed product measured by the tension sensor according to an embodiment example of the third modified example of the present invention.

FIG. 8B is a graph showing a time-series change in variance of acceleration of the roll device 10 measured by the acceleration sensor according to an embodiment example of the third modified example of the present invention.

### DESCRIPTION OF EMBODIMENTS

Hereinafter, embodiments of the present invention will be described in detail with reference to the drawings. In the drawings, an X-axis, a Y-axis, and a Z-axis (spatial axes) orthogonal to each other as needed are shown. In each axis, a direction in which an arrow extends is referred to as a “positive direction” and a direction opposite to the positive direction is referred to as a “negative direction.”

### 1. OVERVIEW OF MANUFACTURING STEPS

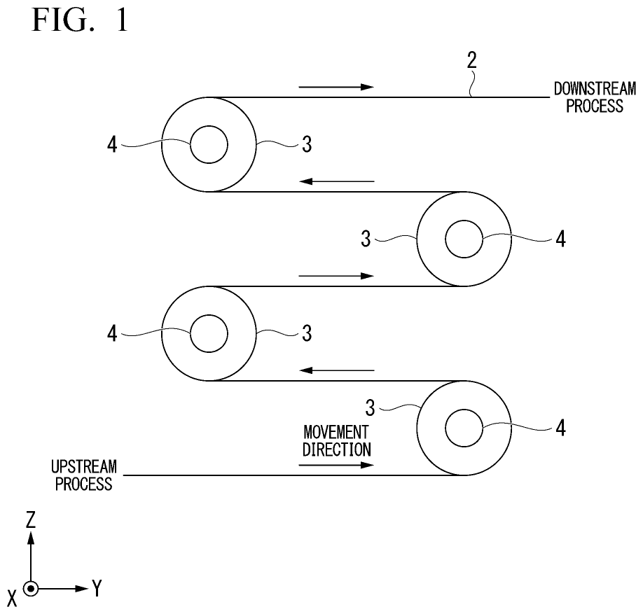

FIG. 1 is a diagram showing an example of manufacturing steps for a workpiece according to an embodiment of the present invention. In FIG. 1, a molding process of molding a workpiece 2 is shown as an example of the manufacturing step. Hereinafter, the present invention will be described as an example in which the molding process for the workpiece 2 is managed.

The workpiece 2 is, for example, fibrous synthetic resin. The synthetic resin is thermoplastic resin having thermoplasticity. In the present embodiment, the synthetic resin is processed in the molding process and a resin processed product such as a film, a sheet, or a fiber is produced. Hereinafter, the resin processed product produced from the synthetic resin will be described as the workpiece 2 in the present embodiment.

In the molding process, as shown in FIG. 1, a plurality of rolls 3 are provided. The roll 3 is an example of a support member according to the present embodiment. The roll 3 comes into contact with the workpiece 2 that moves in a state in which tension is applied and supports the workpiece 2. Also, the number of rolls 3 provided in the molding process and an arrangement thereof are not limited to the example shown in FIG. 1.

The roll 3 rotates around the roll shaft 4. The resin processed product is arranged to be in contact with the roll 3. The resin processed product repeatedly moves in the positive or negative direction of the Y-axis and moves in the positive direction of the Z-axis while being molded (for example, stretched) by the rotation of the roll 3. Thereby, the resin processed product is moved from an upstream process to a downstream process.

In FIG. 1, as an example, the resin processed product and the roll 3 are brought into contact with each other such that the shape of the resin processed product when viewed from the X-axis direction is U-shaped. A method of causing the resin processed product to come into contact with the roll 3 is not limited to the example shown in FIG. 1. The method of causing the resin processed product to come into contact with the roll 3 may change with the arrangement of the roll 3.

### 2. CONFIGURATION OF ROLL DEVICE

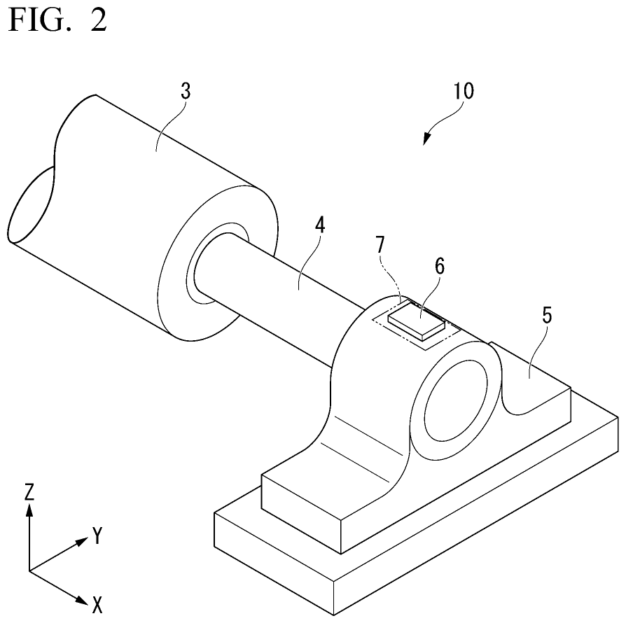

FIG. 2 is a diagram showing an example of a configuration of the roll device according to the embodiment of the present invention. As shown in FIG. 2, the roll device 10 includes a roll 3, a roll shaft 4, a roll bearing 5, and an acceleration sensor 6. The roll 3 is connected to the roll bearing 5 via the roll shaft 4.

A sensor device for detecting the measured value in the roll 3 is provided on the roll device 10. The sensor device is an acceleration sensor 6. The acceleration sensor 6 is easily installed in an existing facility and the acceleration sensor 6 can also be introduced into a place where it is difficult to install a tension sensor due to a restriction such as a high process temperature. The acceleration sensor 6 is attached to the roll device 10. The acceleration sensor 6 is attached to the upper portion of the roll bearing (an area 7 shown in FIG. 2). However, the acceleration sensor 6 may be attached to another position on the roll bearing 5 or may be attached to any other position as long as the vibrations of the roll 3 or the roll shaft 4 can be detected. Also, a plurality of acceleration sensors 6 may be attached to one roll bearing 5.

The acceleration sensor 6 detects the acceleration according to the rotational power of the roll 3. For example, a sensor capable of detecting accelerations in three axial directions is used for the acceleration sensor 6. The manufacturing step management system calculates variance of the detected accelerations (an example of a mechanical change) and estimates the tension applied to the resin processed product on the basis of the calculated variance. However, the manufacturing step management system is not limited to this and the tension may be estimated on the basis of variance of a velocity or a position instead of the acceleration. Also, acceleration, a velocity, or a position for estimating the tension is one in which a positive/negative value is repeated (a mechanical change) when the tension is applied with respect to a measured value when no tension is applied. Also, in the present embodiment, among accelerations detected by the acceleration sensor 6 in the three axial directions, acceleration in a direction in which a change in the tension applied to the resin processed product most strongly acts on a change in the acceleration (i.e., only the acceleration in one axial direction) is used to estimate the tension applied to the resin processed product.

Also, a process condition may be taken into account to detect the mechanical change. The process condition is a condition set in the molding process, for example, a temperature or a production speed related to the physical characteristics of the resin processed product. The process condition significantly affects the residual distortion and the shrinkage stress in the resin processed product. The residual distortion and the shrinkage stress affect the tension applied to the resin processed product. Therefore, it is possible to estimate the tension applied to the resin processed product with higher accuracy by taking into account the process condition to detect the mechanical change. Also, the mechanical change may be obtained in consideration of a process condition such that physical characteristic information about pure resin is obtained.

### 3. FUNCTIONAL CONFIGURATION OF MANUFACTURING STEP MANAGEMENT SYSTEM

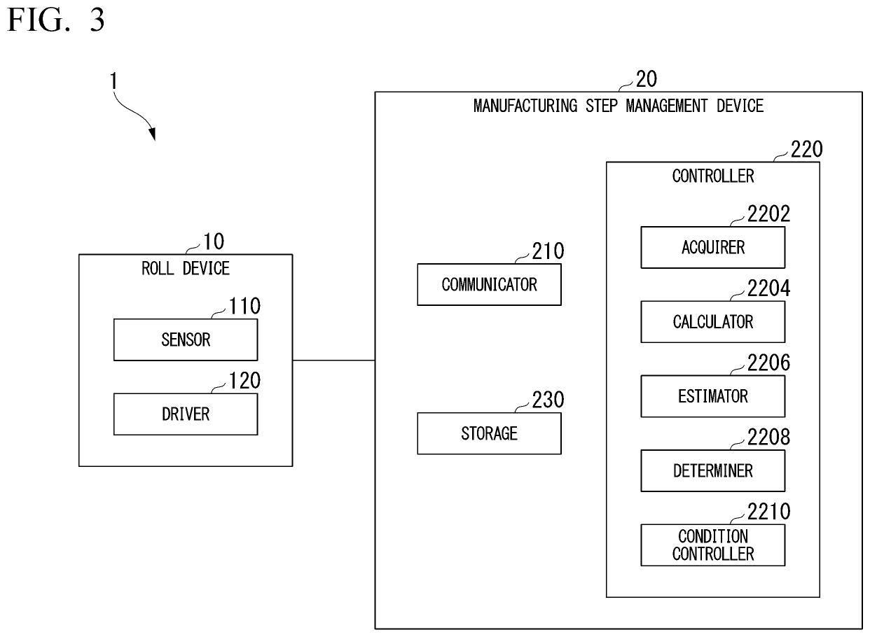

FIG. 3 is a block diagram showing an example of a functional configuration of the manufacturing step management system according to the embodiment of the present invention. As shown in FIG. 3, the manufacturing step management system 1 includes a roll device 10 and a manufacturing step management device 20.

### <3-1. Functional Configuration of Roll Device>

The roll device 10 is a device that performs processing such as stretching on a resin processed product. As shown in FIG. 3, the roll device 10 includes a sensor 110 and a driver 120.

### (1) Sensor 110

The sensor 110 has a function of detecting a measured value in the roll 3. The function of the sensor 110 is implemented by the acceleration sensor 6. The sensor 110 transmits acceleration corresponding to rotational power of the roll 3 detected by the acceleration sensor 6 to the manufacturing step management device 20.

### (2) Driver 120

The driver 120 has a function of driving the roll device 10. The function of the driver 120 is implemented by a motor. The operation of the driver 120 is controlled by the manufacturing step management device 20.

### <3-2. Functional Configuration of Manufacturing Step Management Device 20>

The manufacturing step management device 20 is a device that controls the operation of the roll device 10 to manage the molding process of the resin processed product. The manufacturing step management device 20 is implemented by, for example, a personal computer (PC), a smartphone, a tablet terminal, a server terminal, or the like. As shown in FIG. 3, the manufacturing step management device 20 includes a communicator 210, a controller 220, and a storage 230.

### (1) Communicator 210

The communicator 210 has a function of transmitting and receiving various types of information. For example, the communicator 210 transmits the control information input from the controller 220 to the roll device 10. The control information is, for example, information for controlling the operation of the driver 120 of the roll device 10. Also, the communicator 210 receives the acceleration transmitted from the sensor 110 of the roll device 10 and inputs the received acceleration to the controller 220. Also, the communication in the communicator 210 is performed according to wireless communication.

### (2) Controller 220

The controller 220 has a function of controlling an overall operation of the manufacturing step management device 20. The controller 220 is implemented, for example, by causing a central processing unit (CPU) provided as hardware in the manufacturing step management device 20 to execute a program.

As shown in FIG. 3, the controller 220 includes an acquirer 2202, a calculator 2204, an estimator 2206, a determiner 2208, and a condition controller 2210.

### (2-1) Acquirer 2202

The acquirer 2202 acquires the acceleration. For example, the acquirer 2202 acquires the acceleration received by the communicator 210 from the sensor 110 of the roll device 10. The acquirer 2202 inputs the acquired acceleration to the calculator 2204. The acceleration acquired by the acquirer 2202 is an example of information about the variance of a mechanical change. The information is not limited to acceleration.

### (2-2) Calculator 2204

The calculator 2204 calculates variance of the acceleration on the basis of the acceleration of the roll 3. The calculator 2204 calculates the variance of the acceleration on the basis of the acceleration input from the acquirer 2202. The calculator 2204 inputs information indicating the calculated variance of the acceleration (hereinafter, also referred to as “variance information”) to the estimator 2206.

Here, an example of a method of calculating the variance of acceleration will be described. It is assumed that the acceleration sensor 6 measures 100 points per second, i.e., performs one measurement operation every 0.01 seconds. The calculator 2204 calculates standard deviation as the variance on the basis of measurement results (6000 points) after measurement operations of the acceleration sensor 6 are performed for 1 minute. An acceleration measurement period of the acceleration sensor 6 is not limited to this example. The acceleration measurement period of the acceleration sensor 6 may be appropriately changed, for example, in accordance with accuracy required for tension estimation.

### (2-3) Estimator 2206

The estimator 2206 estimates tension applied to the resin processed product. For example, the estimator 2206 estimates the tension applied to the resin processed product on the basis of variance information input from the calculator 2204. Specifically, the estimator 2206 estimates the tension applied to the resin processed product on the basis of a correlation between the variance information and the tension applied to the resin processed product. The estimator 2206 inputs information indicating the estimated tension (hereinafter, also referred to as “estimation information”) to the determiner 2208.

As an example of estimation, the estimator 2206 estimates a change in the tension applied to the resin processed product on the basis of a correlation between the change in the variance of acceleration and the change in the tension applied to the resin processed product on the tension direction axis defined by the direction of the tension received by the roll 3 from the resin processed product. The estimator 2206 can easily estimate the change in the tension applied to the resin processed product using the correlation.

Also, the correlation between the variance of acceleration and the tension can be either a correlation (positive correlation) or an inverse correlation (a negative correlation) in accordance with a magnitude of the tension.

For example, if the roll 3 rotates in a state in which the roll 3 does not support anything, the roll 3 may vibrate in all directions.

On the other hand, it is assumed that the roll 3 rotates in a state in which the resin processed product is supported by the roll 3, such that the resin processed product moves from the upstream process to the downstream process while the resin processed product is being molded. At this time, if the tension applied to the resin processed product is weak, the vibrations in the roll 3 enable the resin processed product to be pulled in a direction parallel to the resin processed product in accordance with the tension. That is, the number of vibrations (acceleration) also increases when the tension increases and the number of vibrations (acceleration) also decreases when the tension decreases. Therefore, when the tension applied to the resin processed product is weak, the variance of acceleration and the tension have a correlation. On the other hand, when the tension applied to the resin processed product is strong, the vibrations in the roll 3 are limited in the direction parallel to the resin processed product in accordance with the tension. That is, the number of vibrations (acceleration) decreases when the tension increases and the number of vibrations (acceleration) increases when the tension decreases. Therefore, when the tension applied to the resin processed product is strong, the variance of acceleration and the tension have an inverse correlation.

Hereinafter, in the present embodiment, an example in which there is an inverse correlation between the variance of acceleration and the change in tension will be described. Also, in the embodiment examples to be described below, it is shown that the correlation between the change in the variance of the acceleration of the roll 3 and the change in the tension applied to the resin processed product on the tension direction axis is an inverse correlation. Therefore, the estimator 2206 estimates that the change in the tension applied to the resin processed product tends to decrease when the change in the variance of the acceleration tends to increase. On the other hand, the estimator 2206 estimates that the change in the tension applied to the resin processed product tends to increase when the change in the variance of acceleration tends to decrease. Within the accelerations in the three axial directions detected by the acceleration sensor 6, the correlation associated with the axis having the largest change in acceleration can be largest. The relationship between the variance of acceleration and the change in tension in the present embodiment is not limited to an inverse correlation relationship and may be a correlation relationship.

The estimator 2206 may estimate the tension applied to the resin processed product on the basis of at least one process condition of the resin processed product. The process condition is, for example, the process temperature or the production speed of the resin processed product or the like. Thereby, the estimator 2206 can estimate the tension in the resin processed product in consideration of the residual distortion and the shrinkage stress. Therefore, the estimator 2206 can improve the accuracy of estimation of the tension applied to the resin processed product.

### (2-4) Determiner 2208

The determiner 2208 determines a state of the resin processed product on the basis of the estimated tension applied to the resin processed product. For example, the determiner 2208 determines the state of the resin processed product on the basis of the estimation information input from the estimator 2206. The determiner 2208 inputs a determination result of the state of the resin processed product to the condition controller 2210.

For example, when the change in the tension indicated in the estimation information is stable, the determiner 2208 determines that the state of the resin processed product is suitable. As an example of a state in which the change in the tension is stable, there is a state in which a difference between a change in the tension indicated in previously input estimation information and a change in the tension indicated in currently input estimation information is less than a prescribed threshold value.

On the other hand, when the change in the tension indicated in the estimation information is unstable, the determiner 2208 determines that the state of the resin processed product is abnormal. As an example of a state in which the change in tension is unstable, there is a state in which the difference between the change in the tension indicated in the previously input estimation information and the change in the tension indicated in the currently input estimation information is greater than or equal to the prescribed threshold value. As an example of a state in which the difference is greater than or equal to the prescribed threshold value, there is a state in which the change in the tension suddenly increases or decreases. Factors that cause the change in the tension to become unstable include, for example, a case where the resin processed product is wound around the roll 3, a case where the resin processed product is cut, and the like.

The determiner 2208 can determine the position of the resin processed product in an abnormal state. For example, the determiner 2208 identifies the acceleration sensor 6 that has detected the acceleration serving as the major source of the estimation information used for determining the state of the resin processed product. Thereby, the determiner 2208 can ascertain that the state of the resin processed product is abnormal in the roll device 10 provided with the acceleration sensor 6 that has been identified.

### (2-5) Condition Controller 2210

The condition controller 2210 controls a process condition of the resin processed product in accordance with the state of the resin processed product. For example, the condition controller 2210 changes the process condition of the resin processed product in accordance with the determination result input from the determiner 2208. The condition controller 2210 transmits control information indicating the changed process condition to the driver 120 of the roll device 10 via the communicator 210.

When it is determined that the state of the resin processed product is abnormal, the condition controller 2210 changes the process condition of the resin processed product in accordance with the state of the resin processed product. For example, the condition controller 2210 slows down the production speed of the resin processed product. The magnitude of the tension applied to the resin processed product can increase as the production speed increases. Thus, the condition controller 2210 can reduce the magnitude of the tension applied to the resin processed product by slowing down the production speed.

On the other hand, when it is determined that the state of the resin processed product is suitable, the condition controller 2210 accelerates the production speed of the resin processed product. The condition controller 2210 accelerates the production speed to the extent that the state of the resin processed product does not become abnormal. Thereby, the condition controller 2210 can improve the productivity of the resin processed product.

### (3) Storage 230

The storage 230 is configured to store various types of information. The storage 230 includes a storage medium, for example, a hard disk drive (HDD), a flash memory, an electrically erasable programmable read-only memory (EEPROM), a random-access read/write memory (RAM), a read-only memory (ROM), or any combination of these storage media. For the storage 230, for example, a non-volatile memory can be used.

### 4. FLOW OF PROCESS

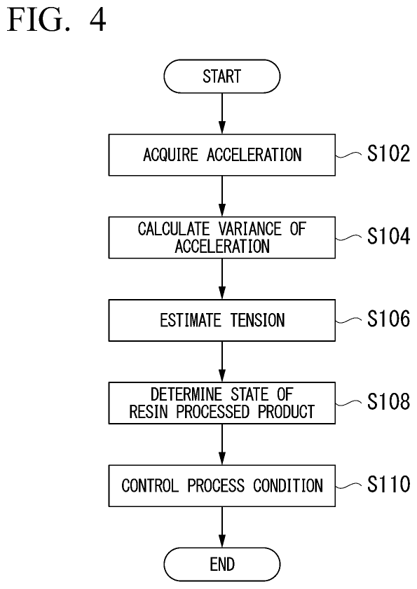

FIG. 4 is a flowchart showing a flow of a process in the manufacturing step management system 1 according to the present embodiment.

As shown in FIG. 4, the manufacturing step management system 1 first acquires acceleration of the resin processed product (S102). Specifically, the sensor 110 (the acceleration sensor 6) of the roll device 10 detects the acceleration of the resin processed product. The sensor 110 transmits the detected acceleration to the manufacturing step management device 20. The acquirer 2202 of the manufacturing step management device 20 acquires the acceleration transmitted from the sensor 110 via the communicator 210.

Subsequently, the manufacturing step management system 1 calculates variance of the acceleration (S104). Specifically, the calculator 2204 of the manufacturing step management device 20 calculates variance information indicating the variance of the acceleration on the basis of the acceleration acquired by the acquirer 2202.

Subsequently, the manufacturing step management system 1 estimates tension applied to the resin processed product (S106). Specifically, the estimator 2206 of the manufacturing step management device 20 estimates estimation information indicating the tension applied to the resin processed product on the basis of a correlation between the variance information calculated by the calculator 2204 and the tension.

Subsequently, the manufacturing step management system 1 determines a state of the resin processed product (S108). Specifically, the determiner 2208 of the manufacturing step management device 20 determines the state of the resin processed product on the basis of the estimation information estimated by the estimator 2206.

Finally, the manufacturing step management system 1 controls a process condition (S110). Specifically, the condition controller 2210 of the manufacturing step management device 20 controls the process condition on the basis of a determination result of a determination process of the determiner 2208.

After the process condition is controlled, the manufacturing step management system 1 may iterate the process from S102.

As described above, the manufacturing step management system 1 according to the present embodiment includes the roll 3 configured to come into contact with a resin processed product that moves in a state in which tension is applied and to support the resin processed product.

The manufacturing step management system 1 calculates the variance of the acceleration on the basis of the acceleration of the roll 3.

The manufacturing step management system 1 estimates the tension applied to the resin processed product.

According to this configuration, the manufacturing step management system 1 estimates the tension applied to the resin processed product on the basis of the acceleration of the roll 3 in contact with the resin processed product. Thereby, the manufacturing step management system 1 can easily estimate the tension applied to the resin processed product without using any tension sensor. That is, even in a facility where it is difficult to introduce the tension sensor, the tension applied to the roll 3 can be easily estimated using a sensor device (the acceleration sensor 6) capable of detecting the acceleration of the roll 3.

Therefore, the manufacturing step management system 1 according to the present embodiment can easily manage the manufacturing steps.

### 5. EMBODIMENT EXAMPLES

In an embodiment example according to the embodiment of the present invention, tension applied to a resin processed product measured using the tension sensor is compared with variance (standard deviation) of acceleration calculated from acceleration of the roll device 10 measured using the acceleration sensor 6. Thereby, it is confirmed that there is a correlation between the tension applied to the resin processed product and the variance of the acceleration of the roll device 10.

In the present embodiment example, the tension sensor may be provided at any position as long as tension propagating from the roll 3 can be measured. Also, in the present embodiment example, the roll 3 in the process (see FIG. 1) in which the resin processed product is U-shaped with respect to the roll 3 is set as an installation target roll for the acceleration sensor 6. A specific installation position of the acceleration sensor 6 is an upper portion (the area 7) of the roll bearing 5 shown in FIG. 2. Also, a direction of the acceleration measured by the acceleration sensor 6 is a direction in which the change in the tension applied to the resin processed product acts most strongly on the change in the acceleration.

In the present embodiment example, it is assumed that the acceleration sensor 6 measures 100 points per second, i.e., performs one measurement operation every 0.01 seconds. The standard deviation of the acceleration is calculated on the basis of measurement results (6000 points) of measurement operations of the acceleration sensor 6 for 1 minute.

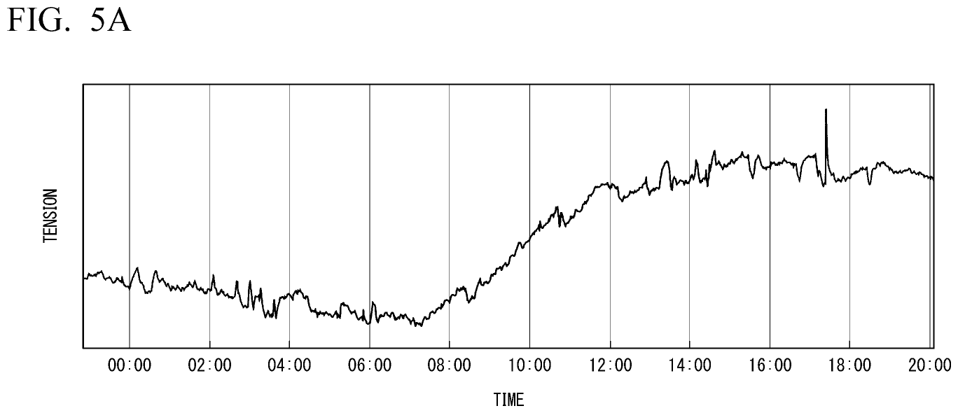

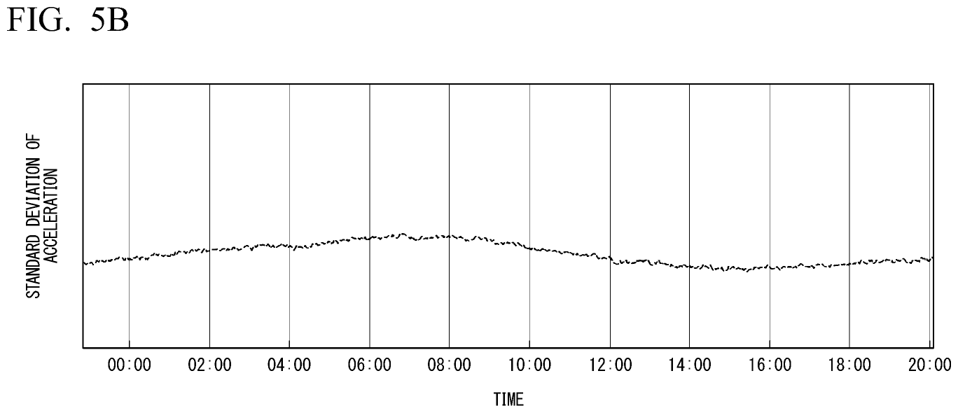

FIGS. 5A and 5B are diagrams for describing an embodiment example of the embodiment of the present invention. FIG. 5A is a graph showing a time-series change in the tension applied to the resin processed product measured by the tension sensor according to the embodiment example of the embodiment of the present invention. The vertical axis of FIG. 5A represents tension and the horizontal axis thereof represents time. FIG. 5B is a graph showing a time-series change in the variance of the acceleration calculated from the acceleration of the roll device 10 measured by the acceleration sensor 6 according to the embodiment example of the embodiment of the present invention. The vertical axis of FIG. 5B represents standard deviation of acceleration and the horizontal axis thereof represents time.

When the time-series change in the tension shown in FIG. 5A is compared with the standard deviation of acceleration shown in FIG. 5B, it can be seen that the standard deviation of the acceleration changes in the form of an inverse correlation (a negative correlation) with the change in the tension. Therefore, it can be said that there is a correlation (a negative correlation) between the tension applied to the resin processed product and the standard deviation (variance) of the acceleration of the roll device 10.

### 6. MODIFIED EXAMPLES

Finally, a modified example of the embodiment of the present invention will be described. Also, modified examples to be described below may be applied to the embodiment of the present invention independently or may be applied to the embodiment of the present invention in combination. Also, each modified example may be applied in place of the configuration described in the embodiment of the present invention or may be additionally applied to the configuration described in each embodiment of the present invention.

### 6-1. First Modified Example

Although an example in which the acceleration sensor 6 is used as the sensor device has been described in the above-described embodiment, the present invention is not limited to this example. A vibration sensor may be used for the sensor device. In this case, the manufacturing step management system 1 estimates the tension applied to the resin processed product on the basis of a value measured by the vibration sensor.

### 6-2. Second Modified Example

Although an example in which the manufacturing step management system 1 estimates the tension applied to the resin processed product on the basis of the acceleration measured by the acceleration sensor 6 has been described in the above-described embodiment, the present invention is not limited to this example. The manufacturing step management system 1 may estimate the tension applied to the resin processed product on the basis of the data obtained by performing a Fourier transform on the acceleration measured by the acceleration sensor 6.

### 6-3. Third Modified Example

Although an example in which the manufacturing step management device 20 estimates tension applied to the resin processed product on the basis of only acceleration in one axial direction in any acceleration among a plurality of accelerations detected by acceleration sensors 6 provided on a plurality of roll devices 10 has been described in the above-described embodiment, the present invention is not limited to this example. For example, the manufacturing step management device 20 may estimate the tension applied to the resin processed product on the basis of accelerations in a plurality of axial directions. Specifically, the manufacturing step management device 20 estimates the tension applied to the resin processed product on the basis of information obtained by a statistical process for accelerations in the plurality of axial directions. Also, it is assumed that information about a plurality of variances is information about a plurality of accelerations (i.e., accelerations measured by the acceleration sensor(s) 6).

Hereinafter, the functions of the manufacturing step management device 20 when the tension applied to the resin processed product is estimated on the basis of a plurality of accelerations will be described in detail. Redundant description of the functions described in the above-described embodiment will be omitted.

### (1) Functional Configuration

The communicator 210 receives the acceleration transmitted from the sensor 110 of the roll device 10 and inputs the received acceleration to the controller 220. Also, the number of sensors 110 for which the communicator 210 receives acceleration is not particularly limited as long as the number is at least one. Also, when the number of sensors 110 for which the communicator 210 receives acceleration is one, it is assumed that the acceleration received by the sensor 110 indicates velocities in at least two axial directions.

The acquirer 2202 acquires accelerations in at least two axial directions from the communicator 210. For example, the accelerations in at least two axial directions are acquired on the basis of accelerations of one roll 3 in at least two spatial axial directions. Specifically, the accelerations in at least two axial directions are accelerations in at least two axial directions among accelerations in the X-axis direction, the Y-axis direction, and the Z-axis direction detected by one acceleration sensor 6 provided on one certain roll device 10. Also, the accelerations in at least two axial directions may be acquired on the basis of accelerations of different rolls 3. Specifically, the accelerations in at least two axial directions are accelerations detected by the acceleration sensors 6 provided on the plurality of roll devices 10. In this case, the accelerations detected by the acceleration sensors 6 may be accelerations in only one axial direction or may be accelerations in a plurality of axial directions.

Also, the accelerations in at least two axial directions are a plurality of accelerations detected by a plurality of acceleration sensors provided on a certain roll device 10. In this case, the accelerations detected by the acceleration sensors 6 may be accelerations in only one axial direction or may be accelerations in a plurality of axial directions.

The calculator 2204 performs a statistical process for accelerations in a plurality of axial directions (information about a plurality of variances) and calculates information used for estimating the tension applied to the resin processed product. For example, the calculator 2204 performs principal component analysis (PCA) as the statistical process for the accelerations in the plurality of axial directions. Specifically, the calculator 2204 calculates the standard deviation (the variance of acceleration) from a first principal component obtained by performing the principal component analysis on the basis of the accelerations in the plurality of axial directions acquired by the acquirer 2202. The calculator 2204 outputs the standard deviation calculated in the principal component analysis to the estimator 2206 as information (variance information) indicating the variance of the acceleration.

Also, the calculator 2204 may calculate the standard deviation after accelerations in a plurality of axial directions outside of a prescribed range are excluded from the accelerations in the plurality of axial directions acquired by the acquirer 2202. For example, the calculator 2204 extracts accelerations in a plurality of axial directions included in the prescribed range from among the accelerations in the plurality of axial directions according to outlier processing and excludes the accelerations outside of the prescribed range from the accelerations in the plurality of axial directions. Preferably, the prescribed range is set such that a more optimum calculation result can be obtained in accordance with a used sensor, an observation system, and the like. For example, if the prescribed range is excessively wide, the reproducibility and variation of the data may be impaired and the impaired reproducibility and variation of the data may affect the calculation result. On the other hand, if the prescribed range is excessively narrow, the outliers, which have not been excluded, may affect the calculation result. In the case of the sensor and the observation system used in the present embodiment, an optimum prescribed range is, for example, 2σ (σ: standard deviation). As described above, the outlier processing is a process for excluding acceleration which is an outlier from the accelerations in the plurality of axial directions used for the principal component analysis. The outlier is a value that deviates significantly from other accelerations that can occur, for example, due to a failure or disturbance of the acceleration sensor. The calculator 2204 can exclude a value that significantly deviates from other accelerations according to the outlier processing. That is, the calculator 2204 can limit an influence of disturbance on the result of the principal component analysis using the accelerations in the plurality of axial directions after the outlier processing. Therefore, the calculator 2204 can improve the accuracy of the principal component analysis according to the outlier processing.

The estimator 2206 estimates tension applied to the resin processed product on the basis of variance information calculated by the calculator 2204 according to the principal component analysis. As an example of estimation, the estimator 2206 estimates a change in the tension applied to the resin processed product on the basis of a correlation between a change in the variance of the acceleration calculated by the calculator 2204 according to the principal component analysis and a change in the tension applied to the resin processed product. The estimator 2206 can easily estimate the change in the tension applied to the resin processed product using the correlation. Also, the estimator 2206 can improve the accuracy of estimation of the tension using variance information calculated by the calculator 2204 according to the principal component analysis for the tension estimation.

Hereinafter, in this modified example, an example in which there is a correlation between the variance of the acceleration and the change in the tension will be described. Also, in the embodiment example of this modified example to be described below, the correlation is shown as a correlation in the tension direction axis between the change in the variance of the acceleration of the roll 3 and the change in the tension applied to the resin processed product. Therefore, the estimator 2206 estimates that the change in the tension applied to the resin processed product also tends to increase when the change in the variance of acceleration tends to increase. On the other hand, the estimator 2206 estimates that the change in the tension applied to the resin processed product also tends to decrease when the change in the variance of acceleration tends to decrease. Also, the relationship between the variance of acceleration and the change in tension in this modified example is not limited to a correlation relationship, but may be an inverse correlation relationship.

### (2) Flow of Process

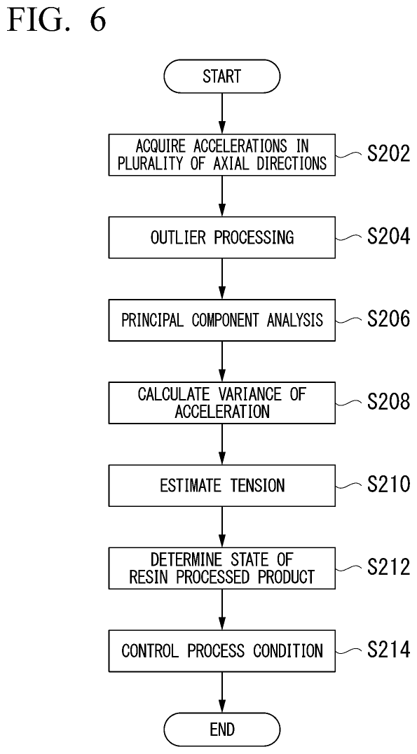

Here, a flow of a process in the manufacturing step management system 1 according to the present modified example will be described with reference to FIG. 6. FIG. 6 is a flowchart showing a flow of a process in the manufacturing step management system according to the third modified example of the present invention.

As shown in FIG. 6, the manufacturing step management system 1 first acquires accelerations in a plurality of axial directions in a resin processed product (S202). Specifically, the sensor 110 (the acceleration sensor 6) of the roll device 10 detects the accelerations of the resin processed product. The sensor 110 transmits the detected accelerations to the manufacturing step management device 20. The acquirer 2202 of the manufacturing step management device 20 acquires accelerations in at least two axial directions from the accelerations transmitted from the sensor 110 via the communicator 210.

Subsequently, the manufacturing step management system 1 performs outlier processing (S204). Specifically, the calculator 2204 of the manufacturing step management device 20 performs the outlier processing for accelerations in a plurality of axial directions acquired by the acquirer 2202 and excludes accelerations outside of a prescribed range.

Subsequently, the manufacturing step management system 1 performs principal component analysis (S206). Specifically, the calculator 2204 of the manufacturing step management device 20 performs the principal component analysis for the accelerations in the plurality of axial directions after the outlier processing.

Subsequently, the manufacturing step management system 1 calculates variance of acceleration (S208). Specifically, the calculator 2204 of the manufacturing step management device 20 calculates variance information indicating the variance of acceleration on the basis of a first principal component (acceleration) obtained in the principal component analysis.

Subsequently, the manufacturing step management system 1 estimates tension applied to the resin processed product (S210). Specifically, the estimator 2206 of the manufacturing step management device 20 estimates estimation information indicating the tension applied to the resin processed product on the basis of a correlation between the variance information calculated by the calculator 2204 and the tension.

Subsequently, the manufacturing step management system 1 determines a state of the resin processed product (S212). Specifically, the determiner 2208 of the manufacturing step management device 20 determines the state of the resin processed product on the basis of the estimation information estimated by the estimator 2206.

Finally, the manufacturing step management system 1 controls a process condition (S214). Specifically, the condition controller 2210 of the manufacturing step management device 20 controls the process condition on the basis of a determination result of a determination process of the determiner 2208.

After the process condition is controlled, the manufacturing step management system 1 may iterate the process from S202.

### (3) Embodiment Example

In the embodiment example according to the third modified example of the present invention, the tension applied to the resin processed product measured using the tension sensor is compared with the variance (standard deviation) of acceleration calculated from three-axial accelerations (i.e., a total of 39 accelerations) of 13 acceleration sensors 6 among acceleration sensors 6 provided on the plurality of roll devices 10. Thereby, it is confirmed that there is a correlation between the tension applied to the resin processed product and the variance of a plurality of accelerations of the roll devices 10.

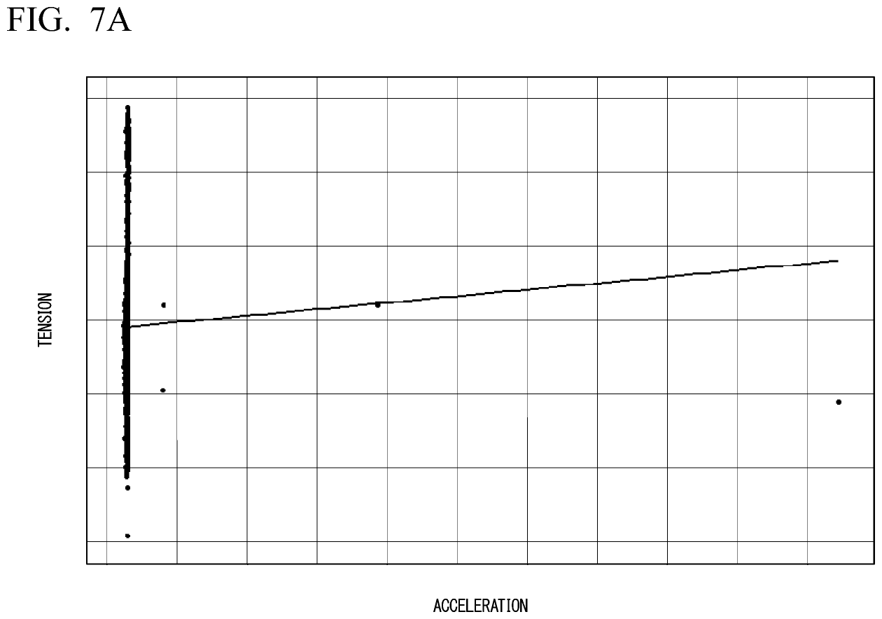

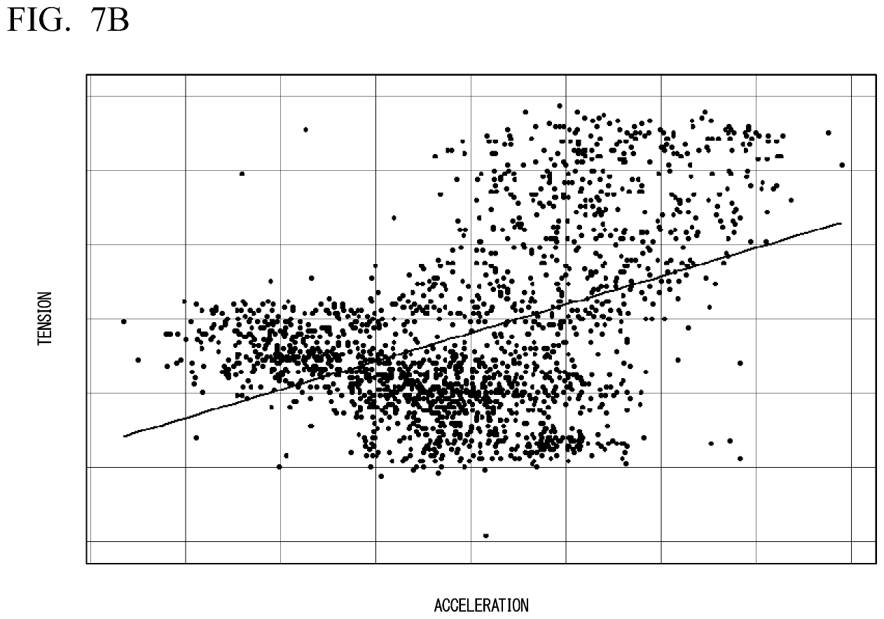

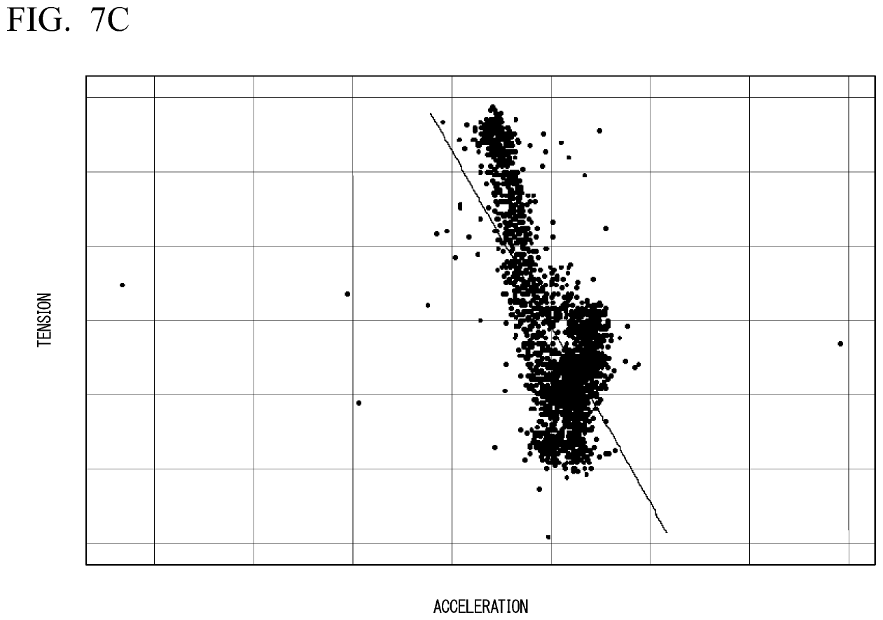

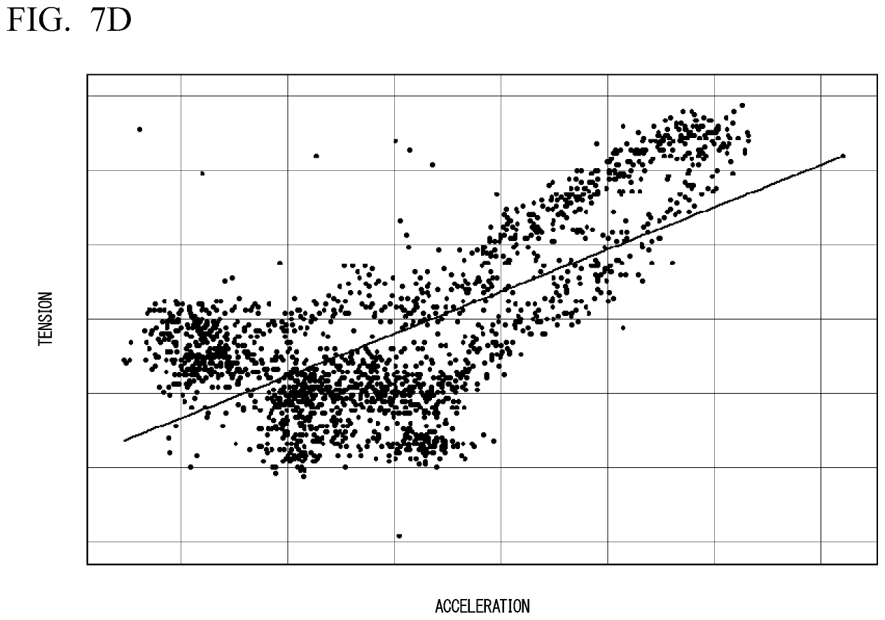

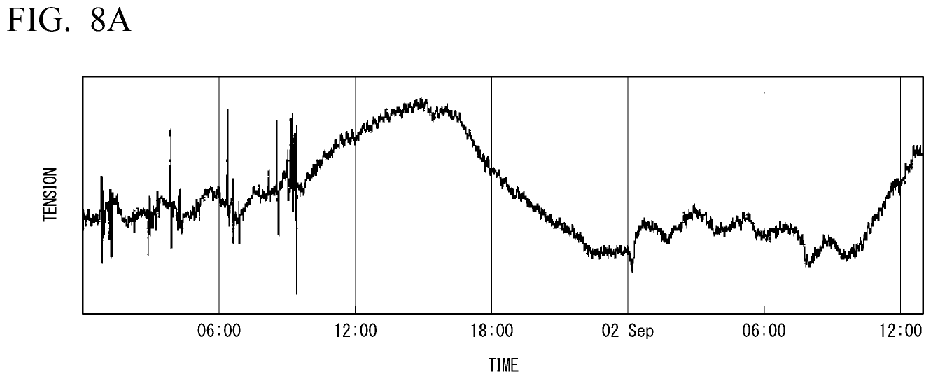

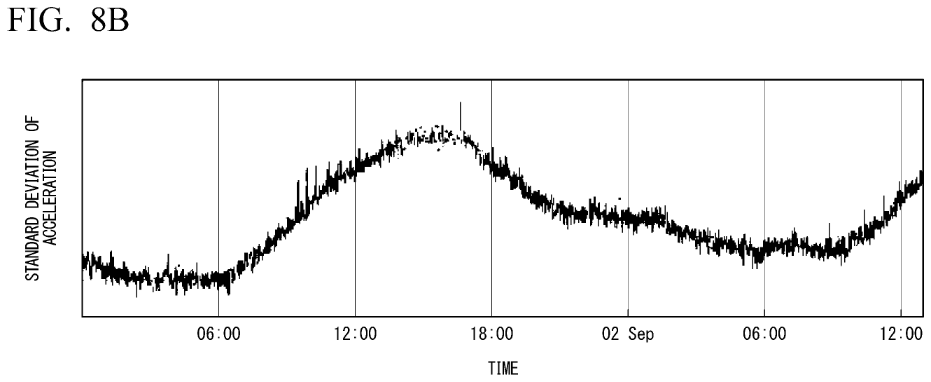

First, FIGS. 7A to 7D, 8A, and 8B are diagrams for describing an embodiment example of the third modified example of the present invention. FIGS. 7A to 7D are diagrams showing the relationship between tension and acceleration corresponding to the presence or absence of a statistical process according to the embodiment example of the third modified example of the present invention. The vertical axis of FIGS. 7A to 7D represents tension actually measured by the sensor device and the horizontal axis represents acceleration actually measured by the sensor device.

FIG. 7A shows a relationship between tension and acceleration when neither the outlier processing nor the principal component analysis is performed with respect to the acceleration in one axial direction in which the acceleration detected by the acceleration sensor 6 provided on a certain roll 3 is shown. A determination coefficient in a scatter plot shown in FIG. 7A was R2=0.001976. From the determination coefficient, it can be said that there is substantially no correlation between tension and acceleration. This is because outliers have an influence.

FIG. 7B is a diagram showing a relationship between tension and acceleration when only outlier processing is performed. A determination coefficient in a scatter plot shown in FIG. 7B was R2=0.191. From the determination coefficient, it can be said that there is a certain correlation between tension and acceleration. This is because the influence of outliers was limited according to the outlier processing.

FIG. 7C is a diagram showing a relationship between tension and acceleration when only principal component analysis is performed. A determination coefficient in a scatter plot shown in FIG. 7C was R2=0.4574. From the determination coefficient, it can be said that the accuracy of a certain correlation is significantly improved as compared with the case where only the outlier processing shown in FIG. 7B is performed.

FIG. 7D is a diagram showing a relationship between tension and acceleration when both outlier processing and principal component analysis are performed. A determination coefficient in a scatter plot shown in FIG. 7D was R2=0.4598. From the determination coefficient, it can be said that the accuracy of a certain correlation is further improved as compared with the case where only the principal component analysis shown in FIG. 7C is performed.

From the above, it can be said that the accuracy of calculation of a correlation between tension and acceleration is improved in order of the case where neither outlier processing nor principal component analysis is performed, the case where only outlier processing is performed, the case where only principal component analysis is performed, and the case where both outlier processing and principal component analysis are performed.

FIGS. 8A and 8B are diagrams showing time-series changes according to an embodiment example of the third modified example of the present invention. FIG. 8A is a graph showing a time-series change in tension applied to a resin processed product measured by the tension sensor according to the embodiment example of the third modified example of the present invention. The vertical axis of FIG. 8A represents tension and the horizontal axis thereof represents tune. FIG. 8B is a graph showing a time-series change in variance of acceleration of the roll device 10 measured by the acceleration sensor according to the embodiment example of the third modified example of the present invention. The vertical axis of FIG. 8B represents standard deviation of acceleration and the horizontal axis thereof represents time.

When the time-series change in the tension shown in FIG. 8A is compared with the standard deviation of acceleration shown in FIG. 8B, it can be seen that the standard deviation of acceleration changes in the form in which there is a correlation (a positive correlation) with the change in tension. Therefore, it can be said that there is a correlation (a positive correlation) between the tension applied to the resin processed product and the standard deviation (variance) of the acceleration of the roll device 10.

The present invention has been described above. The manufacturing step management system 1 according to the above-described embodiment may be configured to be implemented in a computer. In this case, the functions of the manufacturing step management system 1 may be implemented by recording a program for implementing the functions on a computer-readable recording medium and causing a computer system to read and execute the program recorded on the recording medium. Also, the “computer system” described here is assumed to include an operating system (OS) and hardware such as peripheral devices. Also, the “computer-readable recording medium” refers to a flexible disk, a magneto-optical disc, a ROM, a portable medium such as a compact disc (CD)-ROM, or a storage device such as a hard disk embedded in the computer system. Further, the “computer-readable recording medium” may include a computer-readable recording medium for dynamically retaining the program for a short time period as in a communication line when the program is transmitted via a network such as the Internet or a communication circuit such as a telephone circuit and a computer-readable recording medium for retaining the program for a given time period as in a volatile memory inside the computer system including a server and a client when the program is transmitted. Also, the above-described program may be a program for implementing some of the above-described functions. Further, the above-described program may be a program capable of implementing the above-described function in combination with a program already recorded on the computer system or may be a program implemented using a programmable logic device such as a field programmable gate array (FPGA).

Although embodiments of the present invention have been described above in detail with reference to the drawings, specific configurations are not limited to the embodiments and various design changes and the like may be made without departing from the scope of the present invention.

### REFERENCE SIGNS LIST

1 Manufacturing step management system
2 Workpiece
3 Roll
4 Roll shaft
5 Roll bearing
6 Acceleration sensor
7 Area
10 Roll device
20 Manufacturing step management device
110 Sensor
120 Driver
210 Communicator
220 Controller
230 Storage
2202 Acquirer
2204 Calculator
2206 Estimator
2208 Determiner
2210 Condition controller

1. A manufacturing step management system comprising:
a support member configured to come into contact with a workpiece that moves in a state in which tension is applied and to support the workpiece;
an acquirer configured to acquire information about variance of a mechanical change on the basis of the mechanical change in the support member; and
an estimator configured to estimate the tension applied to the workpiece.

2. The manufacturing step management system according to claim 1,
wherein the mechanical change in the support member is acceleration of the support member.

3. The manufacturing step management system according to claim 1, the manufacturing step management system further comprising:
a calculator configured to calculate standard deviation from information about the variance acquired by the acquirer.

4. The manufacturing step management system according to claim 3,
wherein the calculator calculates the standard deviation from a first principal component obtained by performing principal component analysis on the basis of information about a plurality of variances acquired by the acquirer.

5. The manufacturing step management system according to claim 3,
wherein the information about the variance is information about acceleration, and
wherein the calculator excludes a value outside of a prescribed range from the information about the acceleration acquired by the acquirer and calculates the standard deviation.

6. The manufacturing step management system according to claim 5,
wherein information about a plurality of variances is acquired on the basis of the mechanical change for each of different support members.

7. The manufacturing step management system according to claim 4,
wherein information about a plurality of variances is acquired on the basis of the mechanical change in at least two space axes of the support member.

8. The manufacturing step management system according to claim 1,
wherein the estimator estimates the tension applied to the workpiece on the basis of at least one process condition of the workpiece.

9. The manufacturing step management system according to claim 8,
wherein the process condition is a process temperature or a production speed of the workpiece.

10. The manufacturing step management system according to claim 1,
wherein the estimator estimates a change in the tension applied to the workpiece on the basis of a correlation between a change in variance of acceleration in a tension direction axis defined by a direction of the tension received by the support member from the workpiece and the change in the tension applied to the workpiece.

11. The manufacturing step management system according to claim 10,
wherein the correlation in the tension direction axis between the change in the variance of the acceleration of the support member and the change in the tension applied to the workpiece is an inverse correlation, and
wherein the estimator estimates that the change in the tension applied to the workpiece tends to decrease when the change in the variance of the acceleration tends to increase and estimates that the change in the tension applied to the workpiece tends to increase when the change in the variance of the acceleration tends to decrease.

12. The manufacturing step management system according to claim 1, the manufacturing step management system further comprising:
a determiner configured to determine a state of the workpiece on the basis of the estimated tension applied to the workpiece; and
a condition controller configured to control a process condition of the workpiece in accordance with a determination result.

13. The manufacturing step management system according to claim 12,
wherein the condition controller changes the process condition of the workpiece in accordance with the state of the workpiece when the state of the workpiece is determined to be abnormal.

14. The manufacturing step management system according to claim 13,
wherein the condition controller slows down a production speed of the workpiece when the state of the workpiece is determined to be abnormal.

15. The manufacturing step management system according to claim 12,
wherein the condition controller accelerates a production speed of the workpiece when the state of the workpiece is determined to be suitable.

16. The manufacturing step management system according to claim 1,
wherein the workpiece is synthetic resin.

17. The manufacturing step management system according to claim 1,
wherein the workpiece is a fiber.

18. A manufacturing step management device comprising:
an acquirer configured to acquire information about variance of a mechanical change on the basis of the mechanical change in a support member configured to come into contact with a workpiece that moves in a state in which tension is applied and to support the workpiece; and
an estimator configured to estimate the tension applied to the workpiece.

19. A manufacturing step management method comprising:
acquiring, by an acquirer, information about variance of a mechanical change on the basis of the mechanical change in a support member configured to come into contact with a workpiece that moves in a state in which tension is applied and to support the workpiece; and
estimating, by an estimator, the tension applied to the workpiece.

20. (canceled)
